(19) United States
(12) Patent Application Publication
(10) Pub. No.: US 2007/0291449 A1
(43) Pub. Date: Dec. 20, 2007

(54) OTG type storage device and notebook computer using the same

(75) Inventors: Kuo-Hsiung Chen, Taipei (TW); Ching-Sung Yeh, Taipei (TW)

Correspondence Address: BACON & THOMAS, PLLC, 625 SLATERS LANE, FOURTH FLOOR, ALEXANDRIA, VA, 22314, US

(73) Assignee: ASUSTek COMPUTER INC., Taipei (TW)

(21) Appl. No.: 11/812,109

(22) Filed: Jun. 15, 2007

(30) Foreign Application Priority Data
Jun. 16, 2006 (TW) 95121584

(51) Int. Cl. G06F 1/16

(52) U.S. Cl. 361/685; 361/683

(57) ABSTRACT

An OTG type storage device and a notebook computer using the same are provided. The OTG type storage device includes a hard disk, a first controlling module, a battery and at least one hard disk connector. The first controlling module is electronically connected with the hard disk for driving the hard disk. The battery is electronically connected with the hard disk and the first controlling module for providing a working power to the hard disk and the first controlling module. The hard disk connector is used for connecting with a computer system.

This application claims the benefit of Taiwan application Serial No. 095121584, filed Jun. 16, 2006, the subject matter of which is incorporated herein by reference.

### BACKGROUND OF THE INVENTION

1. Field of the Invention

The invention relates in general to an OTG type storage device and a notebook computer using the same, and more particularly to an OTG type storage device with a hard disk connector and a notebook computer using the same.

2. Description of the Related Art

Along with the advance in technology, various electronic products are presented. The notebook computer having the advantages of portability and powerful functions has gradually replaced desk-top computer and become a mainstream products. A conventional notebook computer includes a hard disk, a screen, a keyboard and a host. The host includes a controlling unit. The hard disk is controlled by the controlling unit and driven by a power so as to store, search and transmit data.

However, most users have such an experience that when they go outside, they may need to store the photos of digital camera or copy data to another large volume storage device. To fit such needs, the user has to bring the whole set of computer for data transmission. As the notebook computer includes several components such as hard disk, screen, keyboard and host, when the user's need is limited to data transmission, components such as screen, keyboard and host seem to be redundant and are inconvenient for the user to carry with.

Or, the user may use an additional storage device such as a flash disc, optical disc, memory card or external hard disk as an interim storage device when going outside. Despite such storage devices are convenient to carry with, the above storage devices still have to go with an electronic apparatus when the user would like to transmit or copy data. When it comes to data transmission, the flash disc and the external hard disk both have to go with a computer system, the optical disc has to go with a disc drive or a recorder, and the memory card has to go with a card reader and a computer system, not only incurring additional cost but also causing considerable inconvenience to the user.

### SUMMARY OF THE INVENTION

The invention is directed to an OTG type storage device and a notebook computer using the same are provided. The design of hard disk connector enables the hard disk of the OTG type storage device to be adaptable to two different states. The hard disk is used as a primary hard disc of the notebook computer, and when the user would like to transmit data, the storage device alone will do. Such design provides further convenience to the user but also saves the user cost which would otherwise be spent for purchasing a storage device.

According to a first aspect of the present invention, an OTG type storage device is provided. The OTG type storage device includes a hard disk, a first controlling module, a battery and at least one hard disk connector. The first controlling module is electronically connected with the hard disk for driving the hard disk. The battery is electronically connected with the hard disk and the first controlling module for providing a working power to the hard disk and the first controlling module. The hard disk connector is used for connecting with a computer system.

According to a second aspect of the present invention, a notebook computer including a second controlling module and an OTG type storage device is provided. The OTG type storage device includes a hard disk, a first controlling module, a battery and at least one hard disk connector. The first controlling module is electronically connected with the hard disk for driving the hard disk. The battery is electronically connected with the hard disk and the first controlling module for providing a working power to the hard disk and the first controlling module. The hard disk connector is used for connecting with the second controlling module.

The invention will become apparent from the following detailed description of the preferred but non-limiting embodiments. The following description is made with reference to the accompanying drawings.

### BRIEF DESCRIPTION OF THE DRAWINGS

FIG. 1 is a perspective of an OTG type storage device and a notebook computer using the same according to a preferred embodiment of the invention;

FIG. 2 is a block diagram of the storage device of FIG. 1 disposed in the notebook computer;

FIG. 3 is a diagram of the storage device of FIG. 1 detached from the notebook computer;

FIG. 4 is a block diagram of the storage device of FIG. 3 detached from the notebook computer; and

FIG. 5 is a structural decomposition of the storage device of FIG. 4.

### DETAILED DESCRIPTION OF THE INVENTION

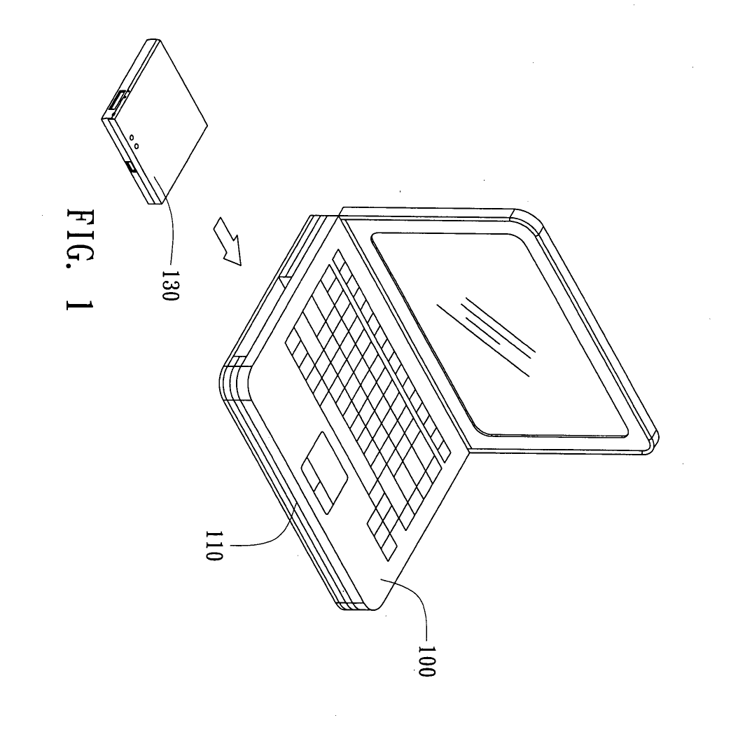

Referring to FIG. 1, a perspective of an OTG type storage device and a notebook computer using the same according to a preferred embodiment of the invention is shown. The notebook computer 100 includes a first housing 110 and an on-the-go (OTG) type storage device 130 (referred as storage device 130 here below). The storage device 130 can be detached from the notebook computer 100 or disposed in the notebook computer 100. When the storage device 130 is detached from the notebook computer 100, the storage device 130 can function independently. When the storage device 130 is disposed in the notebook computer 100, the storage device 130 is used as a primary hard disc of the notebook computer 100. The operations of the storage device 130 under different states are elaborated below.

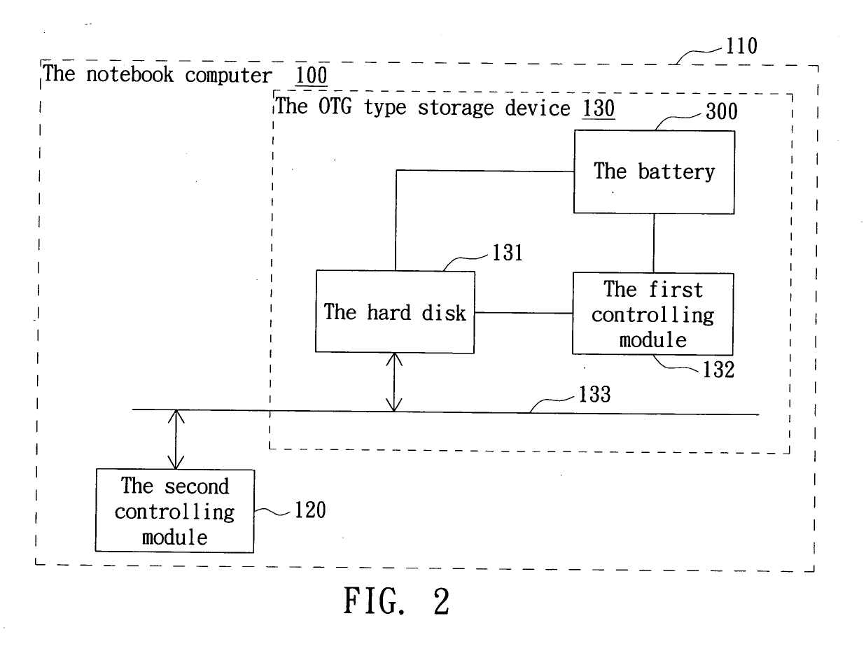

Referring to FIG. 2, a block diagram of the storage device of FIG. 1 disposed in the notebook computer is shown. The notebook computer 100 further includes a second controlling module 120. The second controlling module 120 is a controlling chip module or a main circuit board composed by multiple controlling chip modules. In the present embodiment of the invention, the second controlling module 120 is exemplified by a main circuit board. The storage device 130 includes a hard disk 131, a first controlling module 132, a battery 300 and at least one hard disk connector 133. The dimension of the hard disk 131 includes 1.8 inch, 2.5 inch, 3.5 inch or 5.25 inch. In the present embodiment of the invention, the hard disk 131 is exemplified by a 2.5 inch hard disk most commonly used in the notebook computer 100. However, the dimension and capacity of the hard disk 131 are not for limiting the scope of technology of the invention. The first controlling module 132 is electronically connected with the hard disk 131 for driving the hard disk 131. The first controlling module 132 is exemplified by an OTG chip module. The battery 300 is electronically connected with the hard disk 131 and the first controlling module 132. The battery 300 is a rechargeable battery or a disposable battery. The types and charging methods of the battery 300 are not for limiting the scope of technology of the invention.

The hard disk connector 133 is used for connecting with a computer system. In the present embodiment of the invention, the computer system is exemplified by the notebook computer 100. The hard disk connector 133 corresponds to SATA specification or PATA specification. The types of the hard disk connector 133 are determined according to the specifications. When the storage device 130 is disposed in the first housing 110, the hard disk 131 and the second controlling module 120 are electrically connected via the hard disk connector 133. An electrical signal can be transmitted between the hard disk 131 and the second controlling module 120. The second controlling module 120 drives the hard disk 131, such that the hard disk 131 is used as a primary hard disc of the notebook computer 100.

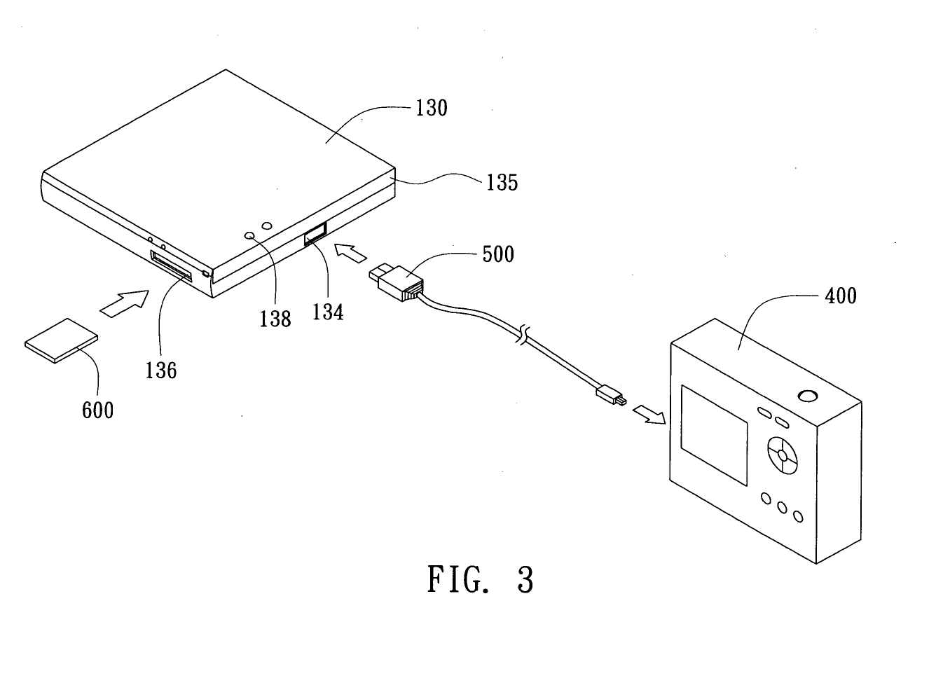

Referring to FIG. 3, a diagram of the storage device of FIG. 1 detached from the notebook computer is shown. When the storage device 130 is detached from the notebook computer 100, the storage device 130 functions independently outside the notebook computer 100. As indicated in FIG. 3, the storage device 130 can exchange data mutually with a memory card 600 or an electronic apparatus 400. Examples of the electronic apparatus 400 include digital camera, multi-functional machine or mobile phone. In the present embodiment of the invention, the electronic apparatus 400 is exemplified by a digital camera. However, the types of the electronic apparatus 400 and the memory card 600 are not for limiting the scope of technology of the invention. As for how the storage device 130 functions independently and the components of the storage device 130 are elaborated below.

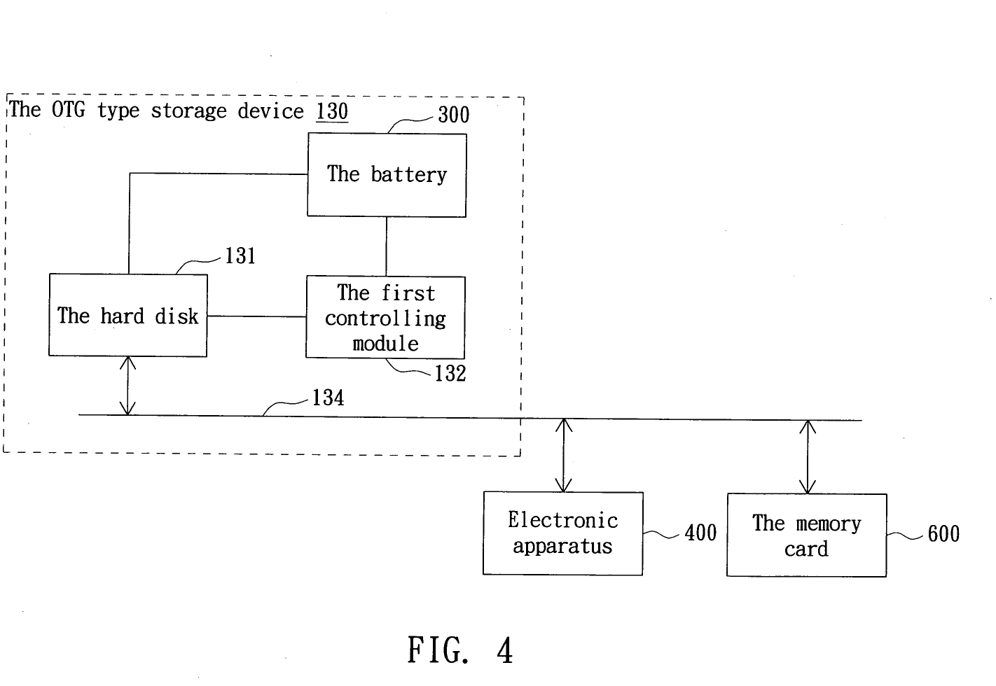

Referring to FIG. 4, a block diagram of the storage device of FIG. 3 detached from the notebook computer is shown. The storage device 130 further includes a first controlling module 132. When the storage device 130 is detached from the notebook computer 100, the hard disk 131, the first controlling module 132 and electronic apparatus 400 are electrically connected via a transmission port 134. The first controlling module 132 transmits an electrical signal to the hard disk 131 for driving the hard disk 131, such that the hard disk 131 respectively exchanges data with the electronic apparatus 400 and the memory card 600. By doing so, the user can exchange data with other electronic apparatus by the storage device 130 alone without using the notebook computer 100.

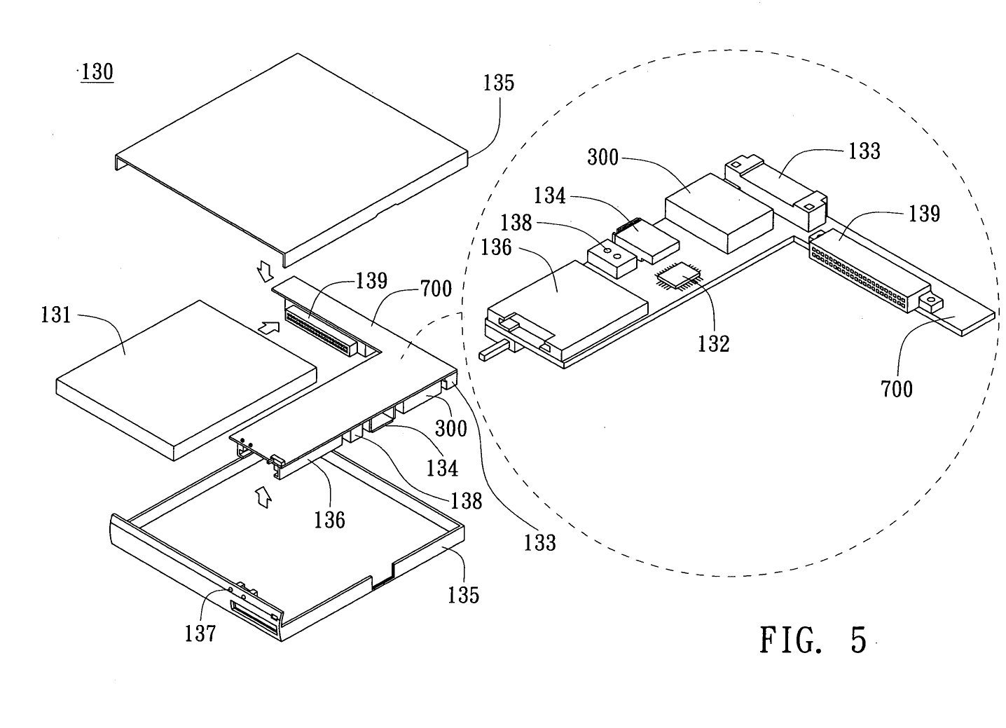

Referring to FIG. 5, a structural decomposition of the storage device of FIG. 4 is shown. The storage device 130 further includes a second housing 135 and a controlling circuit board 700. The second housing 135 retain the controlling circuit board 700 and the hard disk 131 from the top and the bottom to form a complete and independent device for the user to bring with. In the present embodiment of the invention, the first controlling module 132, the hard disk connector 133, the transmission port 134, the hard disk slot 139, the card reader 136 and the controlling interface 138 are all disposed on the controlling circuit board 700. The hard disk 131 is coupled with the hard disk slot 139 and is electronically connected with the hard disk connector 133 via the circuit of the controlling circuit board 700. The hard disk connector 133 is used for connecting with the notebook computer 100 of FIG. 1, such that the hard disk slot 139, the circuit of the controlling circuit board 700 and the hard disk connector 133 are connected to form a bus between the hard disk 131 and the second controlling module 120 of the notebook computer 100 for exchanging electrical signals.

Moreover, the hard disk 131 is coupled with the hard disk slot 139 and is further electronically connected with the transmission port 134 via the circuit of the controlling circuit board 700. The transmission port 134 is used for connecting with the electronic apparatus 400 of FIG. 4. As indicated in FIG. 2, the transmission port 134 is further electronically connected with electronic apparatus 400 via a transmission line 500, such that the hard disk slot 139, the circuit of the controlling circuit board 700, the transmission port 134 and the transmission line 500 are connected to form a bus between the hard disk 131 and the electronic apparatus 400 for exchanging electrical signals. The transmission line 500 is a universal serial bus (USB) transmission line or a 1394 connection line. In the present embodiment of the invention, the transmission line 500 is exemplified by a USB transmission line.

Besides, the hard disk 131 is coupled with the hard disk slot 139 and is further electronically connected with the card reader 136 via the circuit of the controlling circuit board 700. The card reader 136 is used for reading/writing the data of the memory card 600. The hard disk slot 139, the circuit of the controlling circuit board 700 and the card reader 136 are connected to form a bus between the hard disk 131 and the memory card 600 for exchanging electrical signals.

The controlling interface 138 is electronically connected with the first controlling module 132, when the storage device 130 is detached from the first housing 110, the user via the controlling interface 138 controls the storage device 130. In the present embodiment of the invention, the controlling interface 138 is a press button, and the user can press the press button to send a command. The controlling interface 138 has a large variety. However, any one who is skilled in the technology of the invention will understand that the scope of protection of the invention is not limited thereto, and modifications and similar arrangements within the spirit of the invention should be accorded the broadest interpretation so as to encompass all such modifications and similar arrangements.

The storage device 130 is not necessarily powered by a built-in battery 300. The storage device 300 may be powered by alternate current via a power adaptor.

Preferably, the storage device 130 further includes a display interface 137 used for displaying the data of the hard disk 131 such as the storage capacity, transmission state or power state of the hard disk 131, making the hard disk 131 even more convenient to use. The display interface 137 is a light emitting diode (LED) or a liquid crystal display (LCD) panel. In the present embodiment of the invention, the display interface 137 is exemplified by two LEDs as indicated in FIG. 5.

According to the above preferred embodiment, the storage device of the invention is exemplified by simple components. However, the OTG type storage device of the invention still can go with multi-functional accessories such as music player, dissipation module, recording module or audio/video player. Any design enabling the OTG type storage device to function independently and to be disposed in a computer system via a hard disk connector is within the scope of technology of the invention.

An OTG type storage device and a notebook computer using the same are disclosed in the above embodiments of the invention. The design of hard disk connector enables the hard disk of the OTG type storage device to be adaptable to two different states. The hard disk is used as a primary hard disc of the notebook computer, and when the user would like to transmit data, the storage device alone will do. Such design provides further convenience to the user but also saves the user cost which would otherwise be spent for purchasing a storage device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An on-the-go (OTG) type storage device, comprising:
a hard disk;
a first controlling module electronically connected with the hard disk for driving the hard disk;
a battery electronically connected with the hard disk and the first controlling module for providing a working power to the hard disk and the first controlling module; and
at least one hard disk connector used for connecting with a computer system.

2. The OTG type storage device according to claim 1, wherein the computer system comprises a second controlling module, and when the hard disk connector is electrically connected with the computer system, the second controlling module is electronically connected with the hard disk and drives the hard disk, such that the hard disk is used as a primary hard disc of the computer system.

3. The OTG type storage device according to claim 1, further comprising:
a transmission port used for connecting with an electronic apparatus.

4. The OTG type storage device according to claim 3, wherein the transmission port and the electronic apparatus are electrically connected via a transmission line, which is a universal serial bus (USB) transmission line or a 1394 transmission line.

5. The OTG type storage device according to claim 1, wherein the hard disk connector corresponds to SATA specification or PATA specification.

6. The OTG type storage device according to claim 1, wherein the battery is a disposable battery or a rechargeable battery.

7. The OTG type storage device according to claim 1, further comprising:
a card reader used for reading the data of a memory card.

8. The OTG type storage device according to claim 1, further comprising:
a music player used for playing the data of a music media.

9. The storage device according to claim 1, further comprising:
a display interface used for displaying the data of the hard disk.

10. The OTG type storage device according to claim 1, further comprising:
a controlling interface whereby the user controls the hard disk.

11. The OTG type storage device according to claim 10, wherein the controlling interface is a press key.

12. A notebook computer, comprising:
a second controlling module; and
an OTG type storage device, comprising:
a hard disk;
a first controlling module electronically connected with the hard disk for driving the hard disk;
a battery electronically connected with the hard disk and the first controlling module for providing a working power to the hard disk and the first controlling module; and
at least one hard disk connector used for connecting with the second controlling module.

13. The notebook computer according to claim 12, wherein when the hard disk connector is electrically connected with the computer system, the second controlling module is electronically connected with the hard disk and drives the hard disk, such that the hard disk is used as a primary hard disc of the notebook computer.

14. The notebook computer according to claim 12, wherein the storage device further comprises:
a transmission port used for connecting with an electronic apparatus.

15. The notebook computer according to claim 14, wherein the transmission port and the electronic apparatus are electrically connected via a transmission line, which is a universal serial bus (USB) transmission line or a 1394 transmission line.

16. The notebook computer according to claim 12, wherein the battery is a disposable battery or a rechargeable battery.

17. The notebook computer according to claim 12, wherein the OTG type storage device further comprises:
a card reader used for reading a memory card data.

18. The notebook computer according to claim 12, wherein the OTG type storage device further comprises:
a music player used for playing a music media data.

19. The notebook computer according to claim 12, wherein the OTG type storage device further comprises:
a display interface used for displaying the hard disk data.

20. The notebook computer according to claim 15, wherein the OTG type storage device further comprises:
a controlling interface whereby the user controls the hard disk.
